(19) United States
(12) Patent Application Publication
(10) Pub. No.: US 2009/0179729 A1
(43) Pub. Date: Jul. 16, 2009

(54) Thermal fuse employing thermosensitive pellet

(75) Inventor: Tokihiro Yoshikawa, Koka-shi (JP)

Correspondence Address: FASSE PATENT ATTORNEYS, P.A., P.O. BOX 726, HAMPDEN, ME, 04444-0726, US

(73) Assignee: NEC SCHOTT Components Corporation, Koka-shi (JP)

(21) Appl. No.: 12/383,052

(22) Filed: Mar. 18, 2009

Related U.S. Application Data
(62) Division of application No. 11/398,967, filed on Apr. 5, 2006.

(30) Foreign Application Priority Data
Apr. 18, 2005 (JP) 2005-119827

(51) Int. Cl. H01H 85/08

(52) U.S. Cl. 337/401

(57) ABSTRACT

A thermal fuse includes a metallic casing, a first lead member having a first electrode formed at an end thereof, a second lead member having a second electrode formed at an internal wall surface of the casing, a switching function member including a spring member pressing a thermosensitive pellet and a movable conductor. At an operating temperature as the thermosensitive pellet softens and melts, the thermal fuse switches an electrical circuit between the first and second electrodes. In order to respond and switch more quickly at the operating temperature, the thermosensitive pellet is produced to have a structure that facilitates activation thereof at the operating temperature. Such a structure may involve at least one cavity incorporated in the pellet, or may involve at least two different resin materials that are mixed together or provided in plural layers in the pellet.

### CROSS-REFERENCE TO RELATED APPLICATION

This application is a Divisional of U.S. application Ser. No. 11/398,967 filed on Apr. 5, 2006, the entire disclosure of which is incorporated herein by reference.

### BACKGROUND OF THE INVENTION

1. Field of the Invention

The present invention relates generally to a thermal fuse employing a thermosensitive pellet that comprises thermoplastic resin as a thermosensitive material, and relates particularly to a thermal fuse employing a thermosensitive pellet that is improved to allow the thermosensitive material to switch rapidly at a prescribed operating temperature.

2. Description of the Background Art

Thermal fuses are generally divided into two types depending on the thermosensitive material used. One is a thermal fuse employing a thermosensitive pellet using a non-conductive thermosensitive substance, and the other is a thermal fuse employing a conductive, low melting point fusible alloy. They are both a so-called non-reset thermal switch. When its surrounding temperature increases and a prescribed temperature is reached, the fuse operates to cut off or electrically connect a current carrying path of equipment and an apparatus to protect them. A thermal fuse employs a thermosensitive pellet formed of 4-methylumbelliferone serving as a pure chemical agent (hereinafter synonymous with an “organic compound”) as indicated in Japanese Patent Laying-Open No. 60-138819. Furthermore, Japanese Patent Laying-Open Nos. 2002-163966 and 62-246217 both disclose that two or more types of known organic compounds are mixed together to provide a mixture having a different melting point for use. Furthermore, Japanese Patent Laying-Open No. 2003-317589 also suggests a thermal fuse employing a thermosensitive pellet formed of thermoplastic resin to allow a wide range of operating temperature to be set as desired.

### SUMMARY OF THE INVENTION

When a thermal fuse employing a thermosensitive pellet of thermoplastic resin is compared with a thermal fuse employing a thermosensitive pellet comprising a conventional chemical agent, the latter softens, deforms, sublimates and deliquesces more disadvantageously than the former. As such, the former is less affected by environmental conditions and has more merits in steps of processing the same to produce it, and in conditions for storing the same as a finished product, and thus the former is more advantageous in practical use. However, at its operating temperature as the pellet softens or melts, it tends to slowly respond and thus it tends to slowly switch, and this is considered as a disadvantageous issue to be overcome. There is a demand for a thermal fuse employing a thermosensitive pellet that reliably and rapidly operates at a set operating temperature. To achieve this there is a demand for improvement in selecting a thermoplastic resin material used to form the pellet, the force exerted by a spring member, the slidability of a movable contact, and the like.

Furthermore, a thermosensitive pellet is not thermally sufficiently stable and is affected by the surrounding environment, and readily cracks, chips and the like while it is handled in its production process. In addition to addressing such defects, it is also necessary to address a characteristic of operation at an operating temperature as the pellet softens and melts, i.e., quick response. In particular, thermal fuses employing thermoplastic resin have an operating temperature that is set by a combination of how the thermoplastic resin softens and melts, and a spring's pressure. As such, when they are compared with thermal fuses simply utilizing an operation attributed to a melting point of a thermosensitive material, the former tend to provide a time lag or the like when they operate, and accordingly it is required for the former to respond faster at their operating temperature.

To overcome the above disadvantage, the present inventor has noted a response characteristic at an operating temperature of a thermosensitive pellet employing a thermoplastic resin that softens and melts, and has achieved a thermal fuse employing a thermosensitive pellet that is novel and improved to achieve a faster response. More specifically, the present invention provides a thermal fuse employing a thermosensitive pellet of thermoplastic resin having a response characteristic that is compared to a response speed of a thermosensitive pellet employing a conventional, pure chemical substance. Furthermore, the present invention provides a thermal fuse employing a thermosensitive pellet of thermoplastic resin that can be prevented from sublimation around a melting point at an operating temperature to be usable at high temperature, and that is thus thermally stable. Also, the invention provides a thermal fuse employing a thermosensitive pellet that is reduced in or prevented from deliquescence in water and alcohol, and that is enhanced in strength and thus prevented from disadvantageously cracking and chipping. Furthermore the present invention provides a thermal fuse employing a thermosensitive pellet that is increased in dielectric strength at high temperature as well as in response speed. Furthermore the present invention discloses a thermal pellet that covers a wide range of temperature, and that is thermally stable and suitable for mass production. Still further, the invention provides a thermal fuse employing a thermosensitive pellet that is inexpensive and advantageous in practical use.

The present thermal fuse employing a thermosensitive pellet includes a thermosensitive pellet of crystalline thermoplastic resin, a metallic casing accommodating the thermosensitive pellet, a first lead member firmly attached to one end of the casing and having a first electrode formed at an end thereof, a second lead member fixed at the other end of the casing and having a second electrode formed at an internal wall surface of the casing, a switching function member including a spring member disposed internal to the casing and pressing the thermosensitive pellet, and a movable conductor disposed internal to the casing. The thermal fuse switches an electrical circuit between the first and second electrodes at an operating temperature as the thermosensitive pellet softens and melts. The thermosensitive pellet is produced by a process so that it has structural features to facilitate activation of the pellet to allow the thermal fuse to respond faster to switch at the operating temperature.

The process that forms the structural features to facilitate activation of the pellet is preferably a process providing the thermosensitive pellet with bubbles, a recess, a hollowed portion or similar cavity to reduce the weight of the thermosensitive pellet for a given total volume of the pellet, or a process employing different types of thermosensitive resin materials to form the thermosensitive pellet in multiple layers or a mixture of the resin materials. If the thermosensitive pellet is “cavitated” (i.e. has cavities provided therein) and is thus reduced in weight, a “cavitation” (i.e. volume ratio of cavities relative to total pellet volume, expressed as a percentage) of 25 vol % or less is preferable. Note that cavitation is calculated as 100% minus (a solid volume of a pellet without cavitation/an apparent volume of the pellet after it is cavitated), as represented in percentage. Furthermore if the process that facilitates activation utilizes multiple layers or a mixture of resin materials, preferably, different types of resin materials are laminated to provide the multiple layers or mixed together to provide the mixture. The different types of thermoplastic resin materials preferably include a first resin material that determines the general operating temperature and a second resin material that has a melting point lower than the first resin material.

Preferably the thermosensitive pellet is produced in a process including the steps of extruding and thus molding melted thermoplastic resin to produce an extruded wire or rod of the thermoplastic resin, and then cutting the wire or rod to a predetermined length so as to produce a pellet. The production process preferably further includes a process that facilitates activation, which provides cavitation for reduction in weight, laminates different types of resin materials to provide multiple layers, or mixes the different types of resin materials to provide a mixture. The step of extruding and thus molding, which allows the thermosensitive pellet to undergo the process that facilitates activation, makes the thermosensitive pellet more suitable for mass production and thus contributes to a more efficient operation for production. Furthermore the process that facilitates activation can also use both a first feature of cavitating and thus reducing the thermosensitive pellet in weight, and a second feature of employing different types of resin materials in multiple layers and/or a mixture to increase the thermosensitive pellet in strength, and prevent deliquescence as the pellet endures moisture, and thus reduces sublimation at high temperature. Preferably in providing the multiple layers, the resin materials are stacked in layers in the thermosensitive pellet's radial or longitudinal direction, and relative to the first resin material the second resin material has an occupancy in volume of 30 vol % or less. Preferably in mixing the resin materials, relative to the first resin material the second resin material has an occupancy in volume of 30 vol % or less and for example the second resin material may be a colored additive.

If the process that facilitates activation is to reduce the weight of the thermosensitive pellet and is to provide the resin materials of the thermosensitive pellet in multiple layers or a mixture, then preferably the degree of cavity formation for the weight reduction, or the second resin material's occupancy in volume relative to the first resin material in providing the multiple layers or the mixture of the resin materials, is respectively adjusted to fall within a specific range. The resin material that is used is suitably ethylene, propylene, butadiene, isoprene or a similar olefin or diolefin, or a similar polymer or copolymer, or polyolefin. Polyolefin indicates olefin resin or olefin polymer. It is a generic name of aliphatic unsaturated hydrocarbons having a molecule with two or more double bonds therein. Preferably polyolefin includes polyethylene (PE), or polypropylene (PP), as generally referred to, and is adjusted in melt flow rate (MFR) associated with flowability in softening and melting. Note that the thermosensitive material's base material can have a variety of additives, reinforcements and fillers mixed together, or other than a main material selected as a resin material can be polymerized, copolymerized, plasticized or blended, and furthermore the resin can be synthesized and purified with a different catalyst, so as to provide improved physical and electrical characteristics to reinforce the pellet and reduce defects attributed to cracking and chipping.

In accordance with the present invention the thermosensitive pellet formed of thermoplastic resin can be cavitated (i.e. have cavities provided therein) and thus be reduced in weight for a given total pellet volume or size, or the thermosensitive pellet can be formed of different types of resin materials in multiple layers or a mixture, to provide a thermal fuse that can respond faster so as to switch faster and thereby to resolve delay in response at the operating temperature, and can reduce variation among products and thus provide a highly reliable and inexpensive thermal fuse employing a thermosensitive pellet. In contrast, for conventional thermosensitive materials, while they may have the same melting point, they may be a hard or soft material, and if they are slowly increased in temperature their respective operating temperatures provide significant variation. Furthermore, if temperature is rapidly increased, a difference in response time disadvantageously occurs. In the present invention, the process that facilitates activation makes it possible to produce a thermal fuse employing a thermosensitive pellet that can eliminate a varying operating temperature or an effect of response time difference, and can thus provide constantly steady responsiveness.

In particular, employing polyolefin having a degree of crystallinity of at least 20% can facilitate pelletization and provide a pellet improved in strength. Furthermore, if the thermal fuse is placed in high humidity or atmosphere or toxic gas and time elapses, the improved thermal fuse can vary less with time and be prevented from erosion and impaired insulation. Thus not only in storage but also in use, the improved thermal fuse can prevent impaired electrical and other characteristics, reduce secular variation, operate constantly and accurately at a prescribed operating temperature, and help to enhance stability and reliability and provide other similar practical effects. Furthermore the pellet is produced so as to be advantageous for mass production, namely in a process in which melted thermoplastic resin material is extruded and thus molded in a wire or rod form which is then cut to form the pellets, whereby the pellets are enhanced in workability and handleability and contribute to a reduced production cost. Furthermore, the invention inexpensively provides a thermal fuse employing a thermosensitive pellet that can respond faster at an operating temperature.

In accordance with the present invention a thermosensitive pellet is processed so as to facilitate activation of the pellet, to provide a thermal fuse employing the thermosensitive pellet that can respond faster to switch at a prescribed operating temperature, which is set by a combination of a temperature allowing the utilized thermosensitive material to thermally deform, and the pressure exerted by a spring member. Thermoplastic resin softens or melts at a temperature, which is indicated herein by utilizing “extrapolated initial melting temperature (Tim) and extrapolated ending melting temperature (Tem)” as defined by JIS K7121, and MFR as defined in JIS K7210 and corresponding to a characteristic in flowability. Indicating an operating temperature with reference to such JIS standard terms can indicate a characteristic of operation that has a small variation, and that is highly precise and rapid.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 are cross sections of the present thermal fuse employing a thermosensitive pellet before and after operation, respectively.

FIG. 3 represents a relationship between the present thermosensitive pellet's cavitation, operating temperature and response speed.

FIG. 4 represents a relationship between occupancy of the present thermosensitive pellet by different types of resin material, an operating temperature and response speed corresponding thereto.

FIGS. 5A-5G are perspective views of exemplary variations of a thermosensitive pellet used in the present thermal fuse.

### DESCRIPTION OF THE PREFERRED EMBODIMENTS

The present thermal fuse employing a thermosensitive pellet includes a metallic casing housing a thermosensitive pellet of thermoplastic resin, having a first lead member fixed at one end of the metallic casing via an insulated bushing by a sealer and a second lead member crimped and thus fixed at the other end of the metallic casing, and housing a switching function member. The switching function member includes a spring member, a movable conductor, and a thermosensitive pellet that has been produced using a process that can help to activate the fuse at an operating temperature. As the thermosensitive pellet is pressed by the spring member's compression or tensile strength, and heated and hence increased in temperature and thus thermally deformed, the movable conductor moves, and an electrical circuit formed by the first and second lead members is thus switched to be electrically disconnected or connected. Note that the thermosensitive pellet desirably comprises a polyolefin selected from thermoplastic resin, and an operating temperature of the thermal fuse is set between the extrapolated initial melting temperature (Tim) and the peak melting temperature (Tpm) of the polyolefin material of the thermosensitive pellet.

The process that facilitates activation to provide faster response for switching preferably “cavitates” the pellet (i.e. forms or provides at least one cavity in the pellet) and thus reduces the weight of the pellet for a given total pellet volume or size, or the process introduces a different type of resin material (i.e. plural different types of resin materials) in multiple layers or in a mixture in the pellet. The thermoplastic resin is preferably a polyolefin having a crystallinity of at least 20%. It is melted, extruded and thus molded in the form of a wire or rod having a prescribed diameter, and is then cut at a prescribed length and thus pelletized. If the wire or rod is formed in the shape of a pipe it can provide a pellet having a hollowed center and hence a reduced unit weight. Note that the pellet's unit weight indicates the pellet's weight relative to its apparent total volume.

The present invention is based on reducing a thermosensitive pellet in weight, or employing a different type of resin material to provide multiple layers or a mixture of resin materials in the pellet. Such structural modifications of the pellet facilitate its activation to faster respond at a prescribed operating temperature. More specifically, the pellet is reduced in weight (for a given pellet size or total volume) as follows: a thermoplastic resin is used as a thermosensitive material and formed in the form of a pipe with a hollow center or the resin material is provided with bubbles or similarly cavitated (i.e. provided with cavities) . Alternatively, the thermosensitive pellet has a perimeter thereof recessed to provide a discrete pellet reduced in weight. The pellet is preferably reduced in unit weight by a degree corresponding to a percentage of cavitation (i.e. the percentage of the volume of any cavities relative to the total volume of a pellet) of 25% or smaller. Cavitation, operating temperature and response speed have a relationship, which is obtained from a result of providing samples with different degrees of cavitation and testing and thus measuring them. In that case, response speed is a time that elapses before samples that are immersed in a heated oil bath and pressed with a prescribed force, attain a prescribed amount of deformation.

If the thermosensitive pellet is increased in cavitation to some extent, and is pressed with a prescribed force, then it deforms regardless of a temperature at which it softens and melts. As such, there still remains an issue to be addressed in setting the temperature as an operating temperature. The thermal fuse employing the thermosensitive pellet has the pellet thermally deformed at an operating temperature so as to switch and thereby to electrically disconnect or connect a circuit between first and second electrodes. A desired operating temperature can be adjusted typically from a selected thermoplastic resin's melting point, extrapolated initial melting temperature (Tim) and ending melting temperature (Tem), as desired, and also by the force exerted by a spring. Typically, for a low molecular weight compound, a peak melting temperature (Tpm) and an extrapolated ending melting temperature (Tem) having a smaller difference therebetween are most suitable for a material for a thermosensitive pellet for a thermal fuse. Operating temperature can be set by providing the extrapolated initial melting temperature (Tim) and the peak melting temperature (Tpm) with a range (preferably a difference in temperature of at least 5° C.) and setting as desired a value of a load exerted on the thermosensitive pellet.

The thermosensitive pellet is cavitated (i.e. provided with at least one cavity) and thus reduced in weight with a resin material implemented by polyethylene (PE) by way of example, as will be described hereinafter. More specifically, the thermosensitive pellet is provided with bubbles, recessed or hollowed. A cavitation of 0% corresponds to no cavitation (i.e. no cavities) present, and there is an optimum range used for a thermal fuse. Furthermore, the cavitated thermosensitive pellet that is produced by initially melting, and extruding and thus molding thermoplastic resin in the form of a rod and then cutting the wire at a prescribed length, is advantageous in workability. On the other hand, introducing different types of resin materials to provide multiple layers or mixing them together provides faster response at an operating temperature. In that case preferably the different types of resin materials have different melting points, and if a first resin material is a resin material having a desired operating temperature, then a different, second resin material has a melting point lower than the first resin material. For example, PE can be classified by density and has a melting point clearly divided by density, as follows:

low-density polyethylene (LDPE): a density of 0.910-0.935 and a melting point of 105-110° C.; and

high-density polyethylene (HDPE): a density of 0.941-0.965 and a melting point of 130-135° C.

and they can be used as the different types of resin materials.

Furthermore, polyethylene (PE) includes low-density polyethylene (LDPE), linear low-density polyethylene (LLDPE), high-density polyethylene (HDPE), ultrahigh molecular weight polyethylene (ultrahigh molecular weight PE) and very low-density polyethylene (VLDPE), and, as a copolymer, a copolymer of ethylene and acrylic acid (EAA), a copolymer of ethylene and ethylacrylate (EEA), a copolymer of ethylene, methylacrylate (EMA), a copolymer of ethylene and glycidyl methacrylate (GMA), a copolymer of ethylene, methylacrylate and maleic anhydride, and the like. Furthermore, there is a subordinate material for resin classified into an additive, a reinforcement material and a filler for a total of three categories that can be used to adjust an operating temperature.

### FIRST EXAMPLE

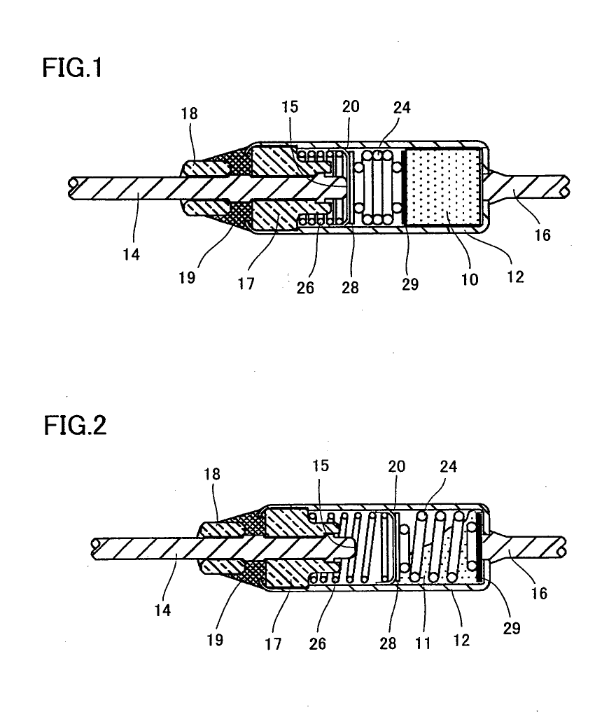

FIGS. 1 and 2 are cross sections of the present thermal fuse employing a thermosensitive pellet before and after operation, respectively. As will be described hereinafter, the present thermosensitive pellet can be processed by a variety of methods to facilitate activation. For the sake of illustration, the present invention employs polyolefin implemented by high density polyethylene HDPE (melting point: 135° C.) and low density polyethylene LDPE (melting point: 110° C.) for a total of two types of resin materials mixed together to produce a thermosensitive pellet 10 processed to facilitate activation. In the present example, as shown in FIG. 1, HDPE or a first resin member and LDPE or a second resin member mixed therewith provide thermoplastic resin, which forms thermosensitive pellet 10 housed in a cylindrical, metallic casing 12 as a component of a member that functions to switch an electrical circuit path.

Metallic casing 12 has one end opening with a first lead member 14 fixed thereto and the other end opening with a second lead member 16 crimped and thus fixed thereto. The first lead member 14, fixed via an insulating bushing 17, is insulated from casing 12 and thus extends therein, and has an end provided with a first electrode 15. The first lead member 14 has an externally guided portion provided with an insulated bushing 18 for protection fixed with resin seal 19 at an opening of casing 12. The second lead member 16 is crimped directly and thus fixed in connection with casing 12 and an internal surface of casing 12 serves as a second electrode. Casing 12 also accommodates a switching function member including thermosensitive pellet 10, a movable conductor 20 having a central contact and a peripheral contact in the form of a star, and a spring member including strong and week springs 24 and 26, respectively.

As shown in FIG. 1, the spring member at normal temperature has strong compression spring 24 acting against the resilience of weak compression spring 26 to press and thus bring movable conductor 20 into contact with the first electrode 15. In particular, strong compression spring 24 can be arranged between thermosensitive pellet 10 and movable conductor 20 with pressure plates 28 and 29 interposed therebetween to facilitate assembly and also allow the spring to provide stable operation. In an abnormal condition associated with increased temperature, as shown in FIG. 2, a prescribed operating temperature is attained and thermosensitive pellet 11 softens or melts and deforms, and thus weak compression spring 26 exerts force to press and thus move movable conductor 20. Strong compression spring 24 is liberated beyond its stroke range. Accordingly, weak compression spring 26 pushes movable conductor 20 within its stroke range, and movable conductor 20 slides on the second electrode provided by the internal surface of the casing 12. Movable conductor 20 thus moved is disconnected from the first electrode 15 to switch off an electrical circuit between the first and second electrodes. Note that the example shows a thermal fuse employing a thermosensitive pellet that is normally turned on and is turned off for an abnormal excessive temperature condition by way of example, but for some arrangement and configuration of the spring member it is also possible to provide a thermal fuse employing a thermosensitive pellet that operates oppositely i.e., that is normally turned off and is turned on in an abnormal condition.

In the present invention the process that facilitates activation is to mix and use different types of resin as the thermoplastic resin employed to form a thermosensitive pellet. Preferably the thermoplastic resins used are all crystalline polyolefin, and the different types of resin include a first resin material softening and melting and determining an operating temperature and a second resin material having a melting point lower than that of the first resin material, and their melting points preferably have a difference in temperature of at least 20° C. If the process that facilitates activation is to provide a thermosensitive pellet with multiple layers or a mixture of different resin materials, it has been found from an experiment described hereinafter that preferably, relative to the first resin material, the second resin material has an occupancy in volume of 30 vol. % or less, i.e., the second resin material/the first resin material is 30% or smaller in volume. In the present example thermosensitive pellet 10 employs HDPE having a crystallinity of at least 20% and a melting point of 135° C. mixed together with LDPE having a melting point of 110° C., to provide a resin material which is in turn formed in a wire or rod form and cut at a prescribed length, and processed.

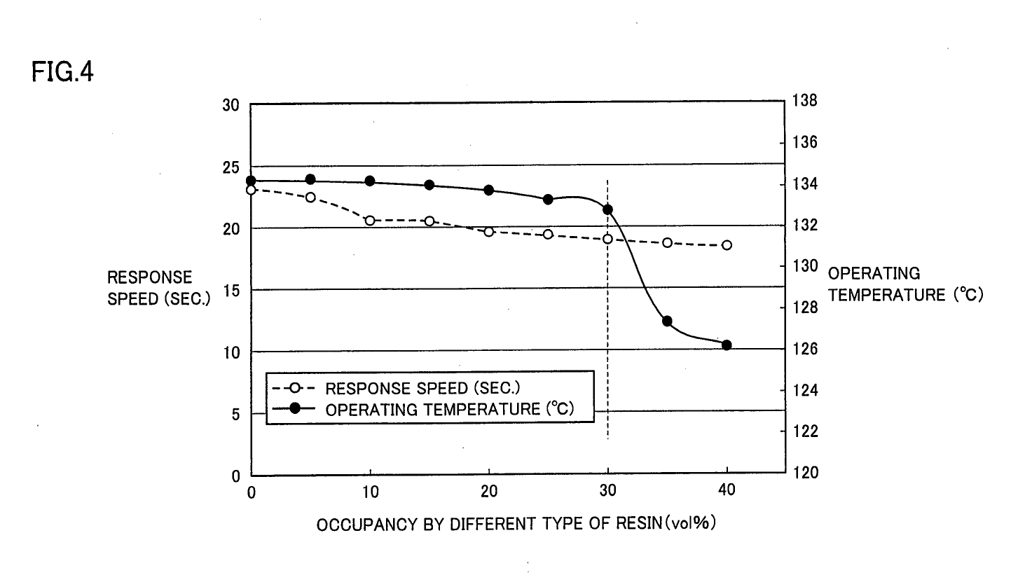

To observe how the thermosensitive pellet employing different types of resin materials provides an effect of different occupancy in volume of the different types of resin materials, nine types of thermosensitive pellets having different occupancy in volume were prepared as samples for an experiment and their response speeds and operating temperatures were tested and measured. Table 1 shows measurements in occupancy, response speed and operating temperature for the different types of resin materials, and FIG. 4 represents a relationship between occupancy, response speed and operating temperature for the different types of resin material. As shown in Table 1 and FIG. 4, desirably the resin materials are mixed to allow the second resin material to have an occupancy in volume of 30% or smaller relative to the first resin material to provide faster response and steady operating temperature. For example if the second resin material is a colored additive for identifying a pellet, the second resin material that has an occupancy in volume of approximately 2% relative to the first resin material can also have an effect to provide faster response.

TABLE 1

| Occupancy of Different | Response Speed | Operating |
|---|---|---|
| Type of Resin Material | (sec.) | Temperature (° C.) |
| 0 | 23.0 | 134.2 |
| 5 | 22.3 | 134.3 |
| 10 | 20.5 | 134.2 |
| 15 | 20.3 | 134.0 |
| 20 | 19.5 | 133.7 |
| 25 | 19.2 | 133.3 |
| 30 | 18.7 | 132.8 |
| 35 | 18.4 | 127.5 |
| 40 | 18.2 | 126.3 |

### SECOND EXAMPLE

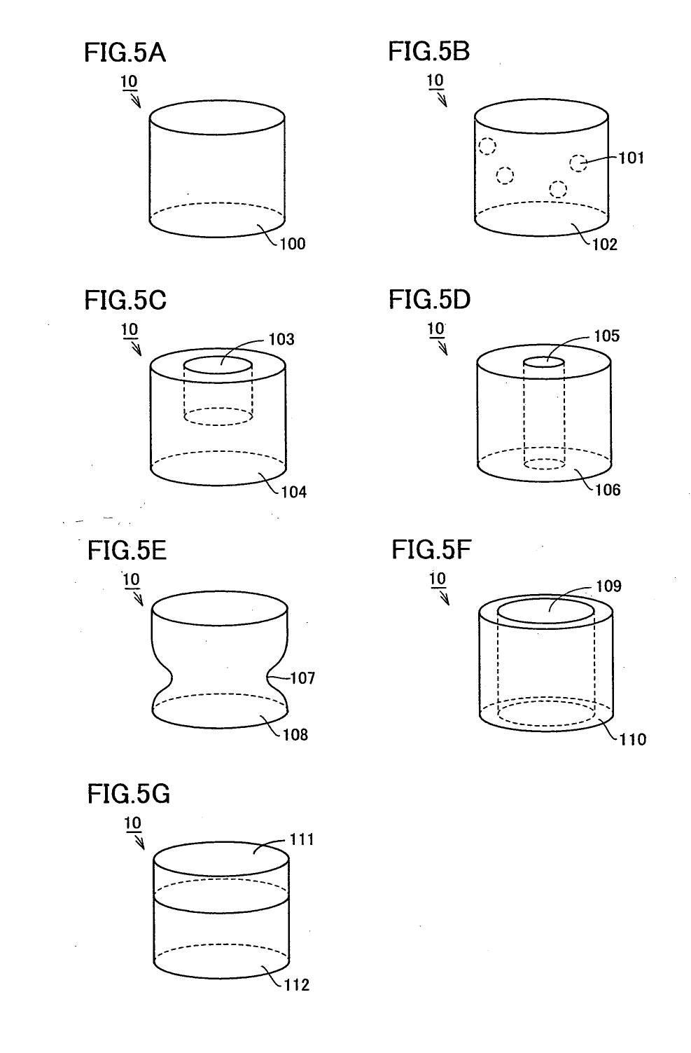

FIGS. 5A-5G are perspective views of exemplary variations of the thermosensitive pellet employed in the thermal fuse. The shown seven types of exemplary variations all effectively provide faster response for switching. FIG. 5A shows a thermosensitive pellet formed of different types of resin materials mixed together and pelletized, and corresponds to thermosensitive pellet 10 described in the first example and formed of the first and second resin materials mixed together. More specifically, the process that facilitates activation is to mix resin materials, and it forms or produces a cylindrical pellet 100 of different resins mixed together. The pellet has a diameter approximately equal to an inner diameter of the casing.

FIGS. 5B-5E show four types of exemplary variations each having a portion cavitated (i.e. provided with at least one cavity) and thus reduced in unit weight. The FIG. 5B pellet is a thermosensitive pellet provided with bubbles 101 and thus cavitated to provide a light, cylindrical pellet 102. The FIG. 5C pellet has a center provided with a hollowed portion or recess 103 to provide a light, cylindrical pellet 104. The FIG. 5D pellet has a center provided with a through hole 105 to provide a light, cylindrical pellet 106. The FIG. 5E pellet has a circumference partially recessed 107 to provide a light, cylindrical pellet 108.

FIGS. 5F and 5G pellets are processed to facilitate activation by providing multiple layers. The FIG. 5F pellet has a first resin material 109 at a radially inner portion and a second resin material 110 surrounding the first resin material 109 to provide the pellet radially with multiple layers by way of example. The FIG. 5G pellet has first and second resin materials 112 and 111, respectively, disposed in the pellet's longitudinal direction to provide multiple layers by way of example.

### THIRD EXAMPLE

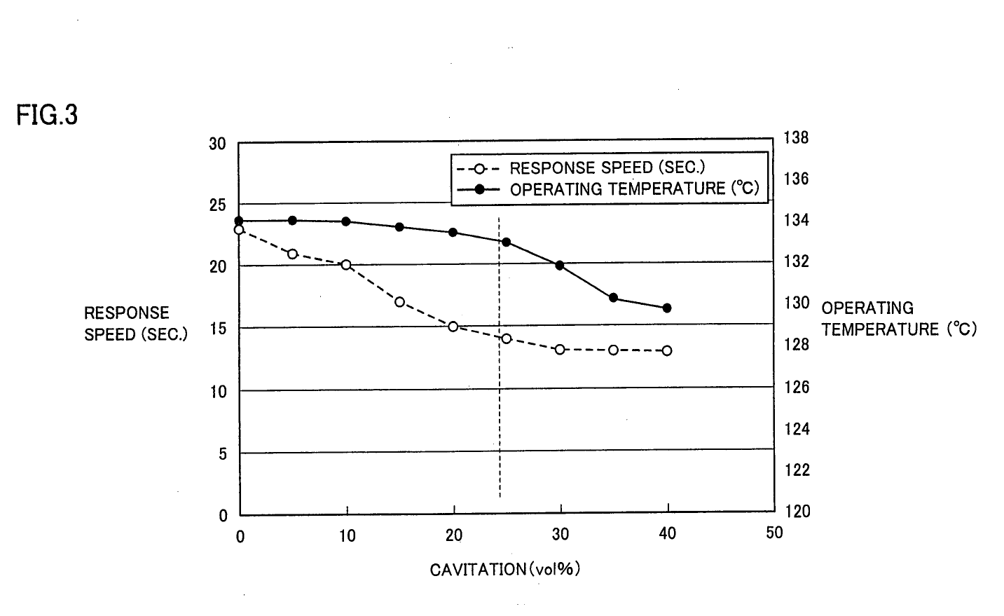

Hereinafter will be described a thermosensitive pellet that is processed to facilitate activation by cavitating and thus reducing the pellet in weight. More specifically, the pellet can be cavitated (i.e. provided with at least one cavity) to be reduced in unit weight to provide increased response speed in switching. As an index, a degree of reduction in weight is represented by the volume percentage of any cavities relative to the total volume of the pellet, or degree of cavitation (vol %). Cavitation, response speed and operating temperature as measured are indicated in Table 2. Furthermore, cavitation, response speed and operating temperature have a relationship as shown in FIG. 3. In the present example, thermosensitive pellets with different cavitation were prepared as samples and each sample was immersed in an oil bath and thus increased in temperature, and an operating temperature causing thermal deformation and a period of time required for a prescribed amount of deformation to occur were measured as response speed, as has been done in the first example. Eight types of thermosensitive pellets or samples with different cavitation, and a comparative sample having no cavitation (or having a cavitation of 0 vol %) were prepared, and they were all tested and measured. As is apparent from a result shown in Table 2 and FIG. 3, it has been found that cavitation is effective in increasing response speed, and a cavitation of 15% or higher and 25% or lower is preferable as such cavitation allows increased response speed and steady operating temperature.

TABLE 2

| | | Operating |
|---|---|---|
| Cavitation (vol %) | Response Speed (sec.) | Temperature (° C.) |
| 0 | 23 | 134.2 |
| 5 | 21 | 134.2 |
| 10 | 20 | 134.1 |
| 15 | 17 | 133.8 |
| 20 | 15 | 133.6 |
| 25 | 14 | 133.1 |
| 30 | 13 | 131.9 |
| 35 | 13 | 130.3 |
| 40 | 13 | 129.8 |

If the process that facilitates activation is to provide different thermoplastic resins in multiple layers or mix thermoplastic resins employed for a thermosensitive pellet, then a first, softening and melting resin material that is selected sets an operating temperature, and the first resin material can be mixed with a second resin material having a melting point lower than that of the first resin material to provide a thermoplastic resin for the thermosensitive pellet. As shown in FIGS. 5F and 5G, a thermosensitive pellet is preferably provided in multiple layers stacked in the pellet's radial or longitudinal directions, respectively, to provide increased response speed and steady operating temperature and facilitate production. Furthermore, if a thermosensitive pellet is provided with different resin materials in multiple layers or a mixture, then as is apparent from the result shown in Table 1 and FIG. 4, it is preferable that, relative to the first resin material, the second resin material has an occupancy in volume of 30 vol % or smaller to provide increased response speed and steady operating temperature.

Thus the thermosensitive material can be implemented by polyolefin having a crystallinity of 20% or higher, and if the first resin material is HDPE having a melting point of 135° C. then the second resin material can be implemented by LDPE having a melting point of 110° C. or LLDPE having a melting point of 115° C. Furthermore, the first and second resin materials can be selected from a PP block copolymer, a random PP or an identical PP type relative to homo PP having a melting point of 170° C. If a thermosensitive pellet prepared as a sample is provided with different resin materials in multiple layers, it is preferable that, relative to the first resin material, the second resin material has an occupancy in volume of 30 vol % or smaller as it can provide increased response speed and steady operating temperature, which is similar to the thermosensitive pellet provided by mixing different resin materials as indicated in Table 1 and FIG. 4.

The thermosensitive pellet is preferably processed to facilitate activation by melting, and extruding and thus molding the thermoplastic resin to produce a wire or rod form (i.e. by a step of wiredrawing), while providing cavitation for weight reduction and providing a lamination of different types of resin materials to provide multiple layers or mixing the different types of resin materials to provide a mixture, as such allows a more efficient operation for production. Furthermore, cavitating (i.e. providing at least one cavity in) a thermosensitive pellet and introducing different types of resin materials in multiple layers or mixing them together can together be effectively applied, and the thermosensitive pellet can respond faster to switch at a prescribed operating temperature.

Although the present invention has been described and illustrated in detail, it is clearly understood that the same is by way of illustration and example only and is not to be taken by way of limitation, the spirit and scope of the present invention being limited only by the terms of the appended claims as well as equivalents thereof.

What is claimed is:

1. A thermal fuse employing a thermosensitive pellet, comprising a metallic casing accommodating a thermosensitive pellet of thermoplastic resin, a first lead member firmly attached to one end of said casing and having a first electrode formed at an end thereof, a second lead member fixed at the other end of said casing and having a second electrode formed at an internal wall surface of said casing, a switching function member including a spring member disposed internal to said casing and pressing said thermosensitive pellet and a movable conductor disposed internal to said casing, wherein the thermal fuse is adapted to switch an electrical circuit between said first and second electrodes at an operating temperature at which said thermosensitive pellet softens and melts, characterized in that said thermosensitive pellet includes at least two different resin materials of at least two different types in a mixture so as to facilitate activation to allow the thermal fuse to respond to switch at said operating temperature faster than without said mixture of said at least two different resin materials.

2. The thermal fuse according to claim 1, characterized in that said thermosensitive pellet comprises said mixture of said different types of said different resin materials in an extruded rod shape.

3. The thermal fuse according to claim 1, characterized in that said different types of said different resin materials include a first resin material determining said operating temperature and a second resin material having a melting point lower than said first resin material.

4. The thermal fuse according to claim 3, characterized in that said mixture contains said second resin material having an occupancy in volume of at most 30 vol % relative to said first resin material.
